(19) United States
(12) Patent Application Publication
(10) Pub. No.: US 2008/0166471 A1
(43) Pub. Date: Jul. 10, 2008

(54) FORMING METHOD FOR PREDETERMINED PATTERN, FORMING METHOD FOR COLORED LAYER, AND MANUFACTURING METHOD FOR ELECTRO-OPTICAL DEVICE

(75) Inventor: Tomomi KAWASE, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/969,683

(22) Filed: Jan. 4, 2008

(30) Foreign Application Priority Data
Jan. 10, 2007 (JP) 2007-002023

(51) Int. Cl. B05D 5/00; B05D 5/12

(52) U.S. Cl. 427/58; 427/256

(57) ABSTRACT

A forming method for a predetermined pattern, includes: measuring the radius of a droplet when the droplet is dropped onto a bank uprightly formed on a substrate; defining a target drop region of the droplet relative to a droplet disposition region delimited by the bank, based on the radius of the droplet; ejecting the droplet from a droplet ejecting section onto the target drop region; and forming the predetermined pattern onto the droplet disposition region.

### CROSS-REFERENCE TO RELATED APPLICATION

This application claims priority from Japanese Patent Application No. 2007-002023, filed on Jan. 10, 2007, the contents of which are incorporated herein by reference.

### BACKGROUND

1. Technical Field

The present invention relates to a forming method for a predetermined pattern, a forming method for a colored layer, and a manufacturing method for an electro-optical device.

2. Related Art

When manufacturing a color filter of a liquid crystal display device by using a droplet ejection method (ink jet method), droplets (ink) to which a pigment is mixed are continuously ejected or applied to each pixel surrounded by a bank (black matrix).

Specifically, the bank having a height of approximately 1 μm and liquid repellency is formed on a substrate. An ink used for a color filter (hereinafter, referred to CF ink) is applied (hereinafter, referred to IJ applying) to the area surrounded by the bank.

However, in the case of applying the large amount of ink in order to realize sufficient color density, there is concern that the ink excessively flows from the bank and mixes (color mixing) into an adjacent pixel.

In order to prevent such a fault, as disclosed in Japanese Unexamined Patent Application, First Publication No. H11-190804, a technique is suggested in which the diameter of a droplet of the CF ink is defined depending on the size of the pixel formation region when applying the CF ink onto the region surrounded by the bank (pixel formation region).

Furthermore, as disclosed in Japanese Unexamined Patent Application, First Publication No. 2005-305242, a technique is suggested in which the diameter of a droplet of the CF ink is modified depending on the drop position of the droplet.

Furthermore, as disclosed in Japanese Unexamined Patent Application, First Publication No. 2001-188116, a technique is suggested in which the timing of the ejection is modified.

Furthermore, as disclosed in Japanese Unexamined Patent Application, First Publication No. 2004-361491, a technique is suggested in which the drop position of the droplet is defined.

According to Japanese Unexamined Patent Application, First Publication No. 2004-361491, though the possibility in that the CF ink excessively flows from the pixel formation region is reduced, there is a problem in that the CF ink is not wetly spread over the entire pixel formation region. Therefore, there is a high possibility that irregularity of CF ink occurs.

### SUMMARY

An advantage of some aspects of the invention is to provide a forming method for a predetermined pattern, a forming method for a colored layer, and a manufacturing method for an electro-optical device, in which it is possible to prevent the excessive flow (color mixing) of the droplet and the occurrence of irregularity of the pattern or the layer when ejecting the droplet onto the droplet disposition region delimited by the bank on the substrate.

A first aspect of the invention provides a forming method for a predetermined pattern, including: measuring the radius of a droplet when the droplet is dropped onto a bank uprightly formed on a substrate; defining a target drop region of the droplet relative to a droplet disposition region delimited by the bank, based on the radius of the droplet; ejecting the droplet from a droplet ejecting section onto the target drop region; and forming the predetermined pattern onto the droplet disposition region.

It is preferable that, in the forming method of the first aspect of the invention, the target drop region be defined as an inner region relative to a region surrounded by the edge of the bank while separating the periphery of the target drop region from the edge of the bank at a distance greater than the radius of the droplet, and the droplet be dropped so as to cause the center of the droplet to be positioned in the inner target drop region.

It is preferable that, in the forming method of the first aspect of the invention, the target drop region be defined depending on the kind of the droplet.

It is preferable that the forming method of the first aspect of the invention further include performing a surface treatment on the bank and the droplet disposition region. In the forming method, the surface treatment for the bank is different from that for the droplet disposition region.

It is preferable that, in the forming method of the first aspect of the invention, a liquid repellency imparting treatment be performed on the bank, and a liquid affinity imparting treatment be performed on the droplet disposition region.

A second aspect of the invention provides a forming method for a colored layer, including: using the forming method for the predetermined pattern described above; ejecting the droplet including a colored material from a droplet ejecting section onto a plurality of pixels delimited by a bank uprightly formed on a substrate; depositing the colored layers in the pixels; and forming a colored pattern on the substrate.

A third aspect of the invention provides a manufacturing method for an electro-optical device that displays colored images by a transmitted light through a colored pattern layer or by a emitted light from the colored pattern layer, the method including forming the colored pattern layer by using the forming method for the colored layer described above.

### BRIEF DESCRIPTION OF THE DRAWINGS

FIG. 1 is a perspective view of a schematic constitution of a droplet ejection apparatus.

FIG. 2 is a diagram illustrating the principle of ejection of liquid material due to the piezo system.

FIGS. 3A and 3B are for explaining a color filter region on a substrate, FIG. 3A is a perspective view showing a color filter region on the substrate, and FIG. 3B is an enlarged plan view showing the color filter region on the substrate.

FIGS. 4A to 4F are cross-sectional views for explaining a manufacturing method for a color filter.

FIG. 5 is a view showing a target drop region of a droplet.

FIG. 6 is a cross-sectional view showing a passive matrix type liquid crystal device.

FIGS. 7A to 7D are perspective views showing examples of electronic devices including a liquid crystal device.

### DESCRIPTION OF EXEMPLARY EMBODIMENTS

Hereinafter, embodiments of a forming method for a predetermined pattern, a forming method for a colored layer, and a manufacturing method for an electro-optical device of the invention will be described with reference to the accompanying drawings.

Droplet Ejection Apparatus

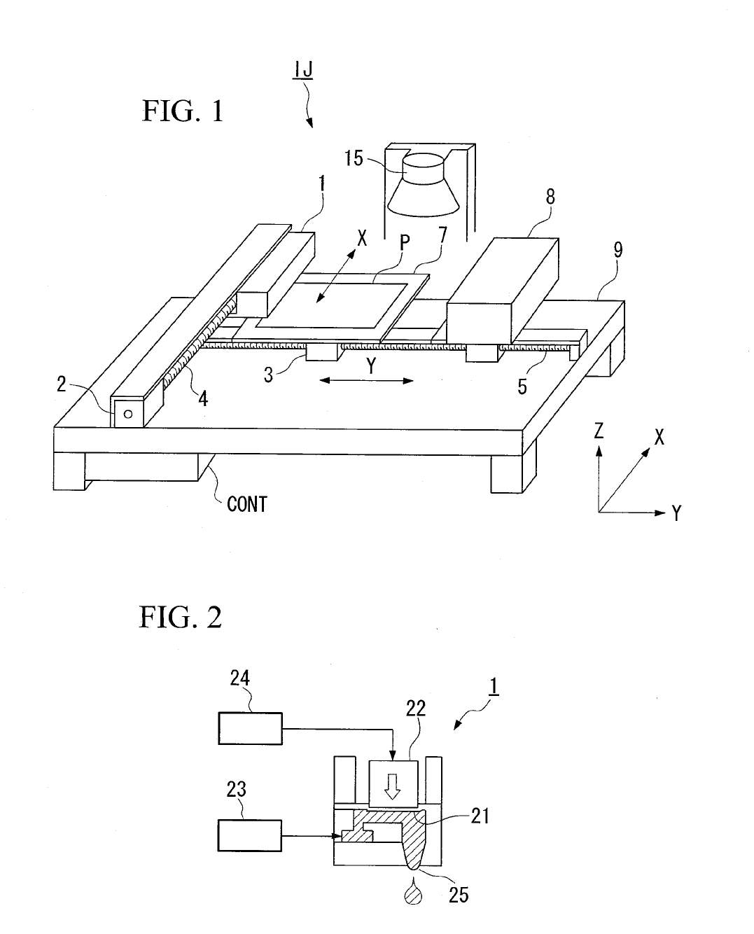

FIG. 1 is a perspective view showing a general configuration of a droplet ejecting apparatus IJ.

In FIG. 1, the droplet ejection apparatus IJ includes a droplet ejecting head (droplet ejecting section) 1, an X-axis direction driving shaft 4, a Y-axis direction driving shaft 5, a control device CONT, a stage 7, a cleaning mechanism 8, a base 9, and a heater 15.

In the description below, the X-axis direction is a scanning direction, while the Y-axis direction, which is orthogonal to the X-axis direction, is a non-scanning direction.

The stage 7 supports a substrate P onto which a color-filter ink is ejected. The color-filter ink is used for manufacturing a color filter. The stage 7 includes a fixing mechanism (not shown) that fixes the substrate P to a reference position.

The droplet ejecting head 1 is of a multi-nozzle type having a plurality of ejection nozzles. A longitudinal direction of the droplet ejecting head 1 coincides with a Y-axis direction.

The plurality of ejection nozzles are provided in a bottom surface of the droplet ejecting head 1 in parallel in the Y-axis direction at regular intervals.

The color-filter ink including the above described colored material is ejected from the ejection nozzles in the droplet ejecting head 1 to the substrate P, supported on the stage 7.

An X-axis direction driving motor 2 is connected to the X-axis direction driving shaft 4.

The X-axis direction driving motor 2 is a stepping motor or the like.

When the control device CONT supplies a driving signal for an X-axis direction to the X-axis direction driving motor 2, the motor 2 rotates the X-axis direction driving shaft 4.

When the X-axis direction driving shaft 4 rotates, the droplet ejecting head 1 moves in the X-axis direction.

The Y-axis direction guide shaft 5 is fixed to the base 9. The stage 7 includes a Y-axis direction driving motor 3. The Y-axis direction driving motor 3 is a stepping motor or the like.

When the control device CONT supplies a driving signal for a Y-axis direction to the Y-axis direction driving motor 3, the motor 3 rotates the Y-axis direction driving shaft 5.

When the Y-axis direction driving shaft 5 rotates, the stage 7 moves in the Y-axis direction.

The control device CONT supplies the droplet ejecting head 1 with a voltage for controlling the ejection of the color-filter ink.

Moreover, the control device CONT supplies the X-axis direction driving motor 2 with a driving pulse signal that controls the movement of the droplet ejecting head 1 in the X-axis direction. The control device CONT supplies the Y-axis direction driving motor 3 with a driving pulse signal that controls movement of the stage 7 in the Y-axis direction.

The cleaning mechanism 8 cleans the droplet ejecting head 1. The cleaning mechanism 8 includes a Y-axis direction driving motor (not shown). The Y-axis direction driving motor drives the cleaning mechanism 8 so that the cleaning mechanism 8 moves along the Y-axis direction guide shaft 5. The control device CONT also controls the movement of the cleaning mechanism 8.

The droplet ejection apparatus IJ ejects color-filter ink to the substrate P while scanning the droplet ejecting head 1 relative to the stage 7, which supports the substrate P.

The ejection nozzles in the droplet ejecting head 1 are formed in parallel at regular intervals in the Y-axis direction, i.e., the non-scanning direction.

In FIG. 1, the droplet ejecting head 1 is placed at a right angle with respect to the direction in which the substrate P advances. However, the angle of the droplet ejecting head 1 may be adjusted so as to cross the advancing direction of the substrate P.

Thus, the pitch between the nozzles can be adjusted based on the angle of the droplet ejecting head 1. Furthermore, the distance between the substrate P and a nozzle surface may be adjustable.

FIG. 2 is a diagram illustrating the principle of ejection of liquid material due to the piezo system.

In FIG. 2, a piezo element 22 is installed adjacent to a liquid chamber 21 that accommodates the liquid material (color-filter ink). The liquid chamber 21 is supplied with the liquid material via a liquid material supply system 23 including a material tank that accommodates the liquid material. The piezo element 22 is connected to the driving circuit 24. A voltage is applied to the piezo element 22 via the driving circuit 24 to deform the piezo element 22. The liquid chamber 21 is thus deformed to eject the liquid material from an ejection nozzle 25. In this case, the value of the applied voltage is varied to control the amount of distortion of the piezo element 22. Furthermore, the frequency of the applied voltage is varied to control the direction speed of the piezo element 22.

As ejecting techniques for the liquid ejection method, a bubble (thermal) system may be adopted. In this system, the liquid material is ejected by generating bubbles due to rapidly vaporizing the liquid material. However, the ejection of droplets based on the piezo system does not involve heating the material. Accordingly, this droplet ejection system has the advantage of avoiding adverse effects on the composition of the material.

Manufacturing Method for a Color Filter and Forming Method for a Predetermined Pattern

Next, an example of a manufacturing method for a color filter 55 by using the droplet ejection apparatus IJ of the embodiment is explained.

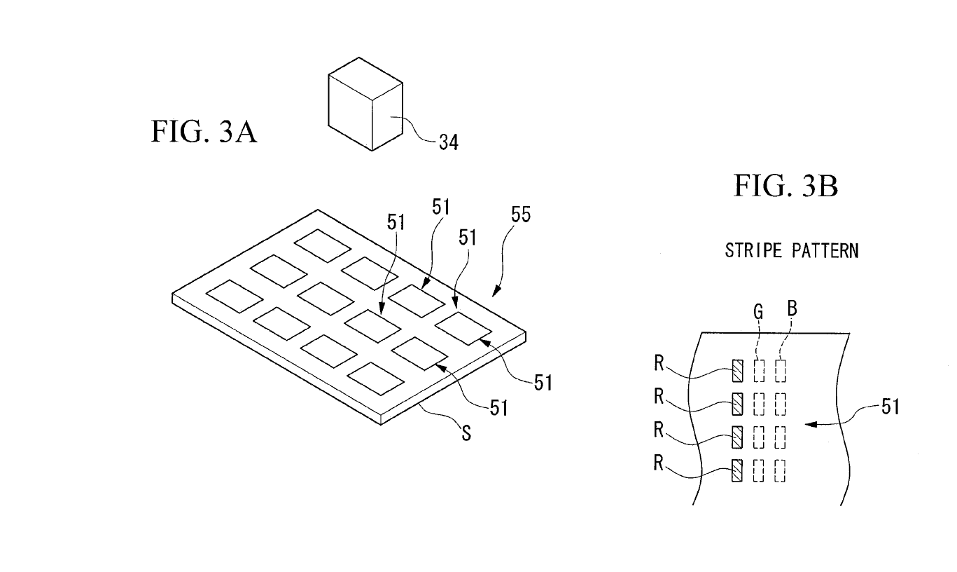

FIG. 3A is a perspective view showing a color filter region on the substrate P.

FIG. 3B is an enlarged plan view showing the color filter region on the substrate P.

In order to improve productivity, the manufacturing method for the color filter by using the droplet ejection apparatus IJ can be applied when a plurality of color filter regions 51 is formed in an arrayed arrangement (matrix arrangement) on a substrate P shaped in a rectangular form.

Due to dice cutting the substrate P, these color filter regions 51 can be used for the color filters 55 adapted to a liquid crystal display device.

In each color filter region 51 as shown in FIGS. 3A and 3B, red ink, green ink, and blue ink are arrayed in a predetermined pattern. In this embodiment, the color filter regions 51 are arrayed in a commonly well-known stripe pattern.

As the formation pattern, a mosaic pattern, a delta pattern, a square pattern, or the like may be also be acceptable.

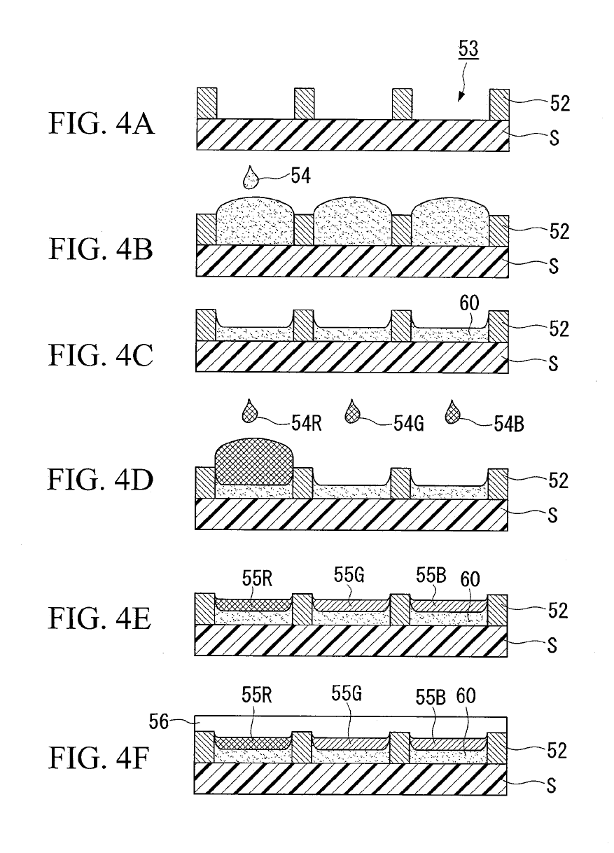

FIGS. 4A to 4F are cross-sectional views for explaining of the manufacturing of the color filter 55.

For the forming the color filter region 51, Firstly, black matrices (bank, black matrix) 52 are formed on one surface of the transparent substrate P as shown in FIG. 4A.

In the formation of the black matrices 52, a non-optically transparent resin (preferably black regin) is applied onto the substrate P at a predetermined thickness (e.g., approximately 2 μm) by a method such as spin coating or the like. Thereafter, the resin is patterned by using a photo lithography technique.

For minimum display elements surrounded by the grid of black matrices 52, that is, filter elements 53 (droplet disposition region), for example, the width in the X-axis direction is approximately 30 μm, and the length in the Y-axis direction is approximately 100 μm.

The black matrices 52 have sufficient height. The black matrices 52 functions as the bank which is used for the ejection of the ink.

Next, as shown in FIG. 4B, an ink droplet 54 including a resin composition which becomes an ink receptive layer is ejected from the droplet ejecting head 1 of the droplet ejection apparatus IJ and is dropped onto the substrate P.

The ink droplet amount 54 ejected from the droplet ejecting head 1 should be a sufficient amount considering the reduction in the volume of ink during heat treatment. Specifically, the ink droplet amount 54 is approximately 10 ng/dot. The multiple ink droplets each of which has the above droplet amount are ejected and dropped.

Next, the ink droplets 54 are cured by a heater 15. Therefore, the ink receptive layer 60 is formed as shown in FIG. 4C.

Next, as shown in FIG. 4D, ink droplets 54R, 54G, and 54B are ejected from the droplet ejecting head 1. The ink droplets 54R, 54G, and 54B are dropped onto the ink receptive layer 60 on the substrate P.

The amount of the ink droplets 54R, 54G, and 54B ejected from the droplet ejecting head 1 should be a sufficient amount considering the reduction in the volume of ink during heat treatment.

As shown in FIG. 4E, an R colored layer 55R, a G colored layer 55G, and a B colored layer 55B are formed.

After forming the R colored layer 55R, the G colored layer 55G, and the B colored layer 55B, the colored layers 55R, 55G, and 55B are cured by the heater 15.

Next, in order to flatten the substrate P and to protect the colored layers 55R, 55G, and 55B, an over coating film (protection film) 56 is formed so as to cover each colored layer 55R, 55G, and 55B and the black matrices 52 as shown in FIG. 4F.

As the forming method for the over coating film 56, a spin coating, a roll coating method, a lip coating method, or the like can be adopted. Also, use of the droplet ejection apparatus IJ can be adopted in a similar manner in that the colored layers 55R, 55G, and 55B are formed.

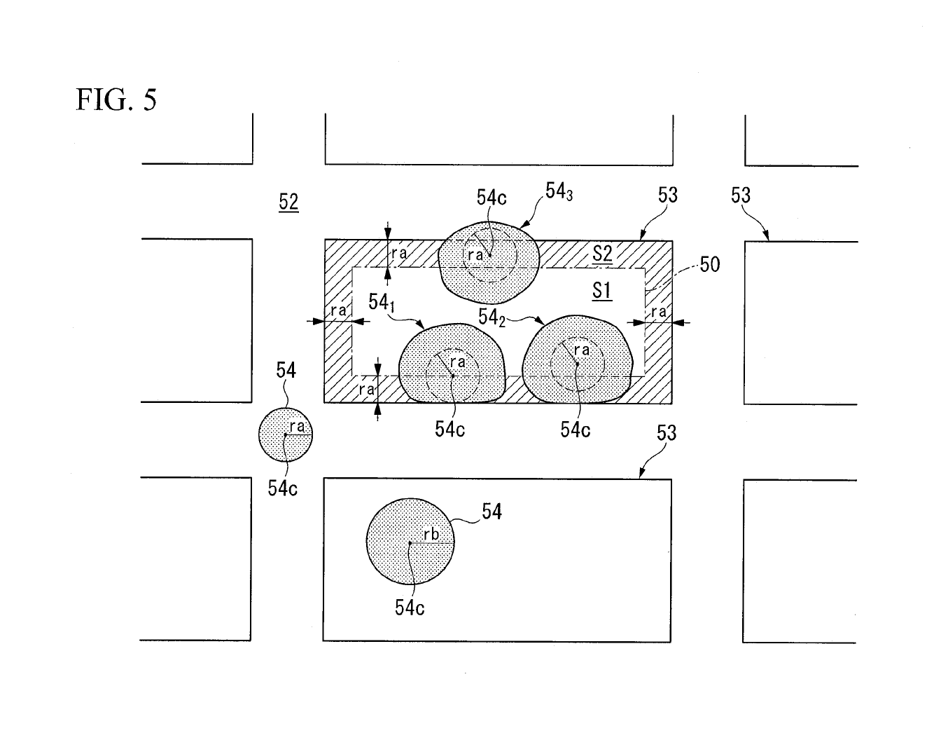

FIG. 5 is a plan view of a target drop region S1 onto which an ink droplet 54 is dropped.

In the case in which the ink droplets 54R, 54G, and 54B are ejected from the droplet ejecting head 1 and dropped onto the ink receptive layer 60 (in the case of FIG. 4D) in the above described manufacturing method for the color filter 55, a target drop region S1 onto which ink droplets 54R, 54G, and 54B are dropped is defined as described below.

A plurality of filter elements 53 (droplet disposition regions) that is surrounded by the black matrix 52 is formed on the substrate P.

The ink receptive layer 60 is formed on the filter element 53. Therefore, a liquid affinity imparting treatment (surface treatment) is performed on the filter element 53.

In contrast, a liquid repellency imparting treatment (surface treatment) is performed on the black matrix 52.

Therefore, in the case of dropping the ink droplets 54 having identical volume and of the same type onto the black matrix 52 and onto the filter element 53, and in the case of measuring the radius ra of ink droplet dropped onto the black matrix 52 and the radius rb of ink droplet dropped onto the filter element 53, and comparing the radius ra with the radius rb, the radius rb is greater than the radius ra as shown in FIG. 5.

In this embodiment, on the basis of the radius ra of the ink droplet 54 when the ink droplet 54 has dropped onto the black matrix 52, the target drop region S1 onto which the ink droplet 54 is dropped on the filter element 53 is defined.

Specifically, the target drop region S1 is defined as an inner region relative to a region surrounded by the outer edge of the filter element 53 (inner edge of the black matrix 52).

Also, there is a space (non-target drop region S2) between the periphery 50 of the target drop region S1 and the outer edge of the filter element 53 at a distance greater than the radius ra of ink droplet 54.

The ink droplet 54 is ejected so as to drop onto the target drop region S1 which is defined as described above.

Thus, the ink droplet 54 is ejected so as not to cause the center 54c of the ink droplet 54 to be positioned in the space (non-target drop region S2) between the periphery 50 of the target drop region S1 and the outer edge of the filter element 53.

As shown in FIG. 5, in the case in which the ink droplets 54 (ink droplets 54₁ and 54₂) that have dropped so as to cause the center 54c of the ink droplet 54 to be positioned in the inner region (center side of the filter element 53) relative to the boundary between the regions S1 and S2, the ink droplets 54 (ink droplets 54₁ and 54₂) are spread in the filter element 53, a part of the ink droplets 54₁ and 54₂ is never mounted on the black matrix 52.

The radius of the ink droplet 54 just before the dropping of the ink droplet 54 onto the substrate P may be a bit less than the radius ra of the ink droplet 54 dropped onto the black matrix 52.

Thus, due to dropping the ink droplet onto the center side region (inside region) of the filter element 53 relative to the periphery 50 of the target drop region S1, which is distanced from the outer edge of the filter element 53 (inner edge of the black matrix 52), the entire ink droplets 54₁ and 54₂ are reliably dropped in the filter element 53.

If a part of the ink droplet 54 has mounted on the black matrix 52 due to the ink droplet 54 being non-spherical form while dropping, the part of the ink droplet 54 that has mounted on the black matrix 52 is drawn into the filter element 53 due to the surface tension between the black matrix 52 and the filter element 53 (ink receptive layer 60), and due to the surface tension of the ink droplet 54.

Therefore, it is possible to avoid mixing (color mixing) the ink droplet 54 into the adjacent filter element 53 (ink receptive layer 60).

In contrast, in the case in which the ink droplet 54 (ink droplet 54₃) is dropped so as to cause the center 54c of the ink droplet 54 to be positioned in the outer region relative to the boundary between the regions S1 and S2, the possibility that a part of the ink droplet 54 mounts on and remains on the black matrix 52 is extremely high. Due to the increase of the ink droplet amount which is mounted of the black matrix 52, the possibility in that the ink droplet 54 is drawn into the filter element 53 is low.

Therefore, the ink droplet 54₃ is divided, and a part of the ink droplet 54₃ (fine droplet) remains on the black matrix 52 while mounting.

In the worst case, the ink droplet 54₃ may be mixed (color mixing) into the adjacent filter element 53.

As the target drop region of the ink droplet 54, a target drop region may be defined on the basis of the radius rb of the ink droplet 54 when the ink droplet is dropped onto the filter element 53. However, in the case of adopting the basis of the radius rb, since the ink droplet amount that is disposed at the boundary portion between the filter element 53 and the black matrix 52 is extremely low, it is difficult to evenly fill the filter element 53 with the ink droplet 54 without irregularity.

In contrast, as the invention, the target drop region S1 of the ink droplet 54 is defined on the basis of the radius ra of the ink droplet 54 when the ink droplet 54 is dropped onto the black matrix 52. Thereby, since the boundary portion between the filter element 53 and the black matrix 52 is filled with a sufficient amount of droplet, the filter element 53 is evenly filled with the ink droplet 54 without irregularity.

The radius ra of ink droplet 54 when the ink droplet 54 is dropped onto the black matrix 52 and the radius rb of ink droplet 54 when the ink droplet 54 is dropped onto the filter element 53 may be defined based on the measurement result by experiment prior to the ejection of the ink droplet 54 or by the result of the prior ejection of the ink droplet 54.

Since, the radius ra and rb may be varied depending on the ink material, it is preferable that the radius ra and rb be previously defined depending on each ink material (ink colors).

Of course, the radius ra and rb may be varied depending on the conditions of the surface treatment or the like, which is performed on the black matrix 52 or the filter element 53 (ink receptive layer 60). Therefore, it is preferable that the radius ra and rb be previously defined depending on each of the conditions of surface treatment.

As described above, according to the forming method for a predetermined pattern of the invention, it is possible to evenly fill the filter element 53 that is delimited by the black matrix 52 with the ink droplet 54 without irregularity.

Also, it is possible to prevent the ink droplet 54 from remaining on the black matrix 52 and the mixing of the ink droplet 54 into the adjacent filter element 53.

Liquid Crystal Device and Electro-Optical Device

Next, an embodiment of a liquid crystal device 30 including the above described color filter 55 is explained.

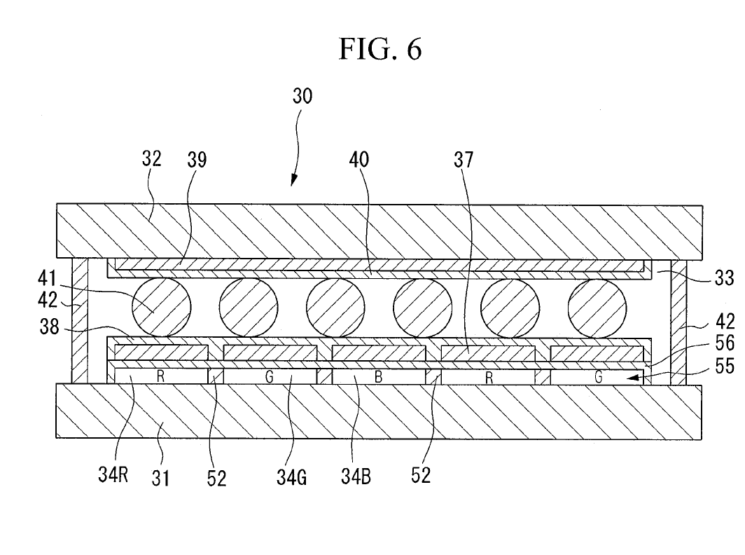

FIG. 6 is a cross-sectional view of a passive-matrix type liquid crystal device 30.

The liquid crystal device 30 is transmission-type, and includes a pair of glass substrates 31 and 32 and a liquid crystal layer 33 having STN (Super Twisted Nematic) liquid crystal or the like. The liquid crystal layer 33 is sandwiched by the pair of glass substrates 31 and 32.

In one of the glass substrates 31 and 32, that is, in the glass substrate 31, the above described color filter 55 is formed on the inner surface of the glass substrate 31.

The color filter 55 includes an R colored layer 55R, a G colored layer 55G, and a B colored layer 55B constituting R (Red), G (Green), and B (Blue), respectively. The R colored layer 55R, the G colored layer 55G, and the B colored layer 55B are arrayed regularly.

The black matrix 52 is formed between the colored layers 55R, 55G, and 55B.

The over coating film (protection film) 56 is formed over the color filters 55R, 55G, and 55B and the black matrix 52, in order to eliminate a difference in level caused by the color filter 55 and the black matrix 52 and to flatten the difference.

A plurality of electrodes 37 is formed on the over coating film 56 in a stripe pattern.

An oriented film 38 is formed on the electrodes 37.

In the other of the glass substrates 31 and 32, that is, in the glass substrate 32, a plurality of electrodes 39 is formed on the inner surface of the glass substrate 32 in a stripe pattern orthogonal to the electrodes 37 formed on the color filter 55. An oriented film 40 is formed on the electrodes 39.

Each colored layer 55R, 55G, and 55B of the color filter 55 is disposed at the position at which the electrodes 37 of the glass substrate 31 intersect the electrodes 39 of the glass substrate 32.

The electrodes 37 and 39 are formed from a transparent conductive material such as ITO (Indium Tin Oxide) or the like.

Furthermore, polarizing plates (not shown) are provided on the outer surface side of the glass substrate 32 and the color filter 55, respectively.

Spacers 41 are provided in order to conserve the spacing (cell gap) between the glass substrates 31 and 32.

Furthermore, in order to enclose the liquid crystal 33 between the glass substrate 31 and 32, a sealing member 42 is disposed between the glass substrate 31 and 32.

Since the color filter 55 is applied to the liquid crystal device 30 of the embodiment, and since the color filter 55 is manufactured by using the above described droplet ejection apparatus IJ, it is possible to obtain a color liquid crystal display device achieving low cost and high quality.

Electronic Device

Next, a specific example of the electronic device including a display section constituted by the above liquid crystal device 30 is explained.

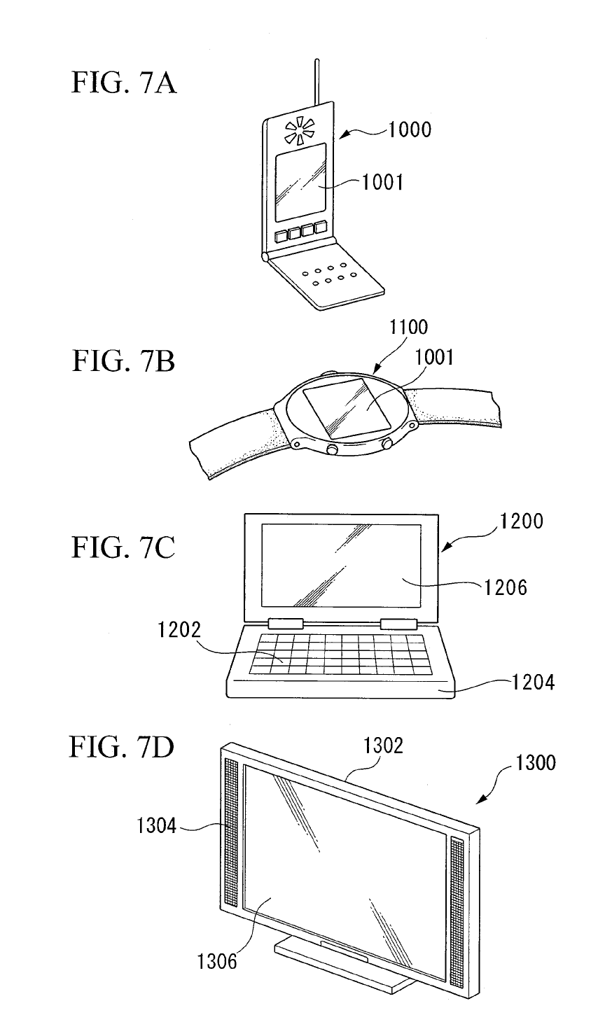

FIGS. 7A to 7D are perspective views showing examples of electronic device including the above liquid crystal device 30.

FIG. 7A is a perspective view of an example of a mobile phone.

In FIG. 7A, a mobile phone 1000 includes a display section 1001 in which the above described liquid crystal device 30 is used.

FIG. 7B is a perspective view of an example of a wristwatch-type electronic device.

In FIG. 7B, a wristwatch 1100 includes a display section 1001 in which the above described liquid crystal device 30 is used.

FIG. 7C is a perspective view of an example of a portable information processing device such as a word processor and a personal computer.

In FIG. 7C, an information processing device 1200 includes an input portion such as a keyboard 1202, a display section 1206 in which the above described liquid crystal device 30 is used, and a main unit of the information processing device (case) 1204.

FIG. 7D is a perspective view of an example of large flat panel display television.

In FIG. 7D, the large flat panel display television 1300 includes a main body 1302, a sound output section 1304 such as a speaker or the like, and a display section 1306 in which the above described liquid crystal device 30 is used.

The technical scope of this invention shall not be limited to the above embodiments. As a matter of course, the invention may include various modifications of the embodiment in a scope not deviating from the spirit of this invention.

For example, with regard to a concrete detail constitution or the like in the droplet ejection apparatus IJ of the above described embodiment, the constitution may be variously modified.

In the above described embodiment, the case of manufacturing the color filter 55 of the liquid crystal device 30 by using the droplet ejection apparatus IJ has been explained. However, the invention is not limited to this embodiment.

For example, when forming a light emitting layer (colored layer) of an organic electro-luminescence (EL) display device by using the droplet ejection apparatus IJ, the forming method for the predetermined pattern of the invention may be used.

In addition, not only in the case of forming the color pattern such as a light emitting layer, the color filter 55, or the like, but also in the case of forming the pattern such as metal wirings or the like, the forming method for the predetermined pattern of the invention can be used.

What is claimed is:

1. A forming method for a predetermined pattern, comprising:
measuring the radius of a droplet when the droplet is dropped onto a bank uprightly formed on a substrate;
defining a target drop region of the droplet relative to a droplet disposition region delimited by the bank, based on the radius of the droplet;
ejecting the droplet from a droplet ejecting section onto the target drop region; and
forming the predetermined pattern onto the droplet disposition region.

2. The forming method according to claim 1, wherein
the target drop region is defined as an inner region relative to a region surrounded by the edge of the bank while separating the periphery of the target drop region from the edge of the bank at a distance greater than the radius of the droplet, and wherein
the droplet is dropped so as to cause the center of the droplet to be positioned in the inner target drop region.

3. The forming method according to claim 1, wherein
the target drop region is defined depending on the kind of the droplet.

4. The forming method according to claim 1, further comprising:
performing a surface treatment on the bank and the droplet disposition region, wherein
the surface treatment for the bank is different from that for the droplet disposition region.

5. The forming method according to claim 4, wherein
a liquid repellency imparting treatment is performed on the bank, and a liquid affinity imparting treatment is performed on the droplet disposition region.

6. A forming method for a colored layer, comprising:
using the forming method according to claim 1;
ejecting the droplet including a colored material from a droplet ejecting section onto a plurality of pixels delimited by a bank uprightly formed on a substrate;
depositing the colored layers in the pixels; and
forming a colored pattern on the substrate.

7. A manufacturing method for an electro-optical device that displays colored images by a transmitted light through a colored pattern layer or by a emitted light from the colored pattern layer, the method comprising:
forming the colored pattern layer by using the forming method according to claim 6.
